(19) United States
(12) Patent Application Publication
(10) Pub. No.: US 2020/0085228 A1
(43) Pub. Date: Mar. 19, 2020

(54) Kettle With Removable Tea Steeper

(71) Applicant: Hamilton Beach Brands, Inc., Glen Allen, VA (US)

(72) Inventors: Stephen C. Williamson, Arvonia, VA (US); Pan Yun, Shenzhen (CN)

(21) Appl. No.: 16/131,231

(22) Filed: Sep. 14, 2018

(51) Int. Cl. A47J 31/20; A47G 19/16

(52) U.S. Cl. CPC A47J 31/20; A47J 31/4403; A47G 19/16

(57) ABSTRACT

An apparatus for brewing a beverage comprises a container portion defining a reservoir and having an open top end, a lid for selectively closing off the top end, an elongated rod selectively insertable through a through-hole of the lid and slidingly movable relative to the lid when inserted, a basket adapted for receiving and holding an infusible material, and a grasping portion selectively attachable to and separable from an upper end of the rod. The basket is attached to a lower end of the rod and selectively insertable into the reservoir through the open top end. The basket has a plurality of holes defined therein adapted to allow water in the reservoir to enter the basket and contact the infusible material when the basket is inserted into the reservoir. Up and down movement of the grasping portion correspondingly moves the basket up and down within the reservoir.

The present disclosure relates generally to small appliances, and more particularly to appliances for brewing beverages such as tea.

Electric tea kettles are a common household appliance and are capable of heating water in a reservoir for brewing tea (or other beverages brewed from an infusible foodstuff). Some of these tea kettles have a steeping basket that is supported by the kettle lid and hangs down into the reservoir. In some tea kettles, the steeping basket is movable up and down by a user to submerge the basket or to raise the basket out of the water. Tea leaves or other infusible foodstuff is placed in the steeping basket and the basket is submerged in the hot water for a desired amount of steeping time. The basket may then be raised out of the water, and the tea may be dispensed from the tea kettle.

When the user is done with the tea and ready to clean the kettle, the lid and steeping basket can be removed from the main body of the kettle for cleaning. However, the lid and steeping basket are not separable by the user. The inseparable lid and steeping basket have a structure and shape that is somewhat difficult to clean. For example, the awkwardly shaped structure of the combined lid and steeping basket may not fit well and/or sit stably on a dishwasher rack.

It has heretofore not been discovered how to create a tea kettle with the ability to separate the lid and steeping basket for easy cleaning. The tea kettle of the following disclosure overcomes at least one of the above-described disadvantages of conventional tea kettles.

### BRIEF SUMMARY OF THE DISCLOSURE

An apparatus for brewing a beverage is disclosed herein. In one embodiment of the subject device, an apparatus for brewing a beverage comprises a container portion defining a reservoir and having an open top end, a lid for selectively closing off the top end, an elongated rod selectively insertable through a through-hole of the lid and slidingly movable relative to the lid when inserted, a basket adapted for receiving and holding an infusible material, and a grasping portion selectively attachable to and separable from an upper end of the rod. The basket is attached to a lower end of the rod and selectively insertable into the reservoir through the open top end. The basket has a plurality of holes defined therein adapted to allow water in the reservoir to enter the basket and contact the infusible material when the basket is inserted into the reservoir. When (i) the grasping portion is attached to the rod, (ii) the basket is in the reservoir, and (iii) the lid is closing off the open end, up and down movement of the grasping portion correspondingly moves the basket up and down within the reservoir.

The grasping portion may comprise at least one release actuator which, when actuated, enables the grasping portion to be separated from the upper end of the rod.

A hole may be defined in a bottom side of the grasping portion for selectively receiving the upper end of the rod when the grasping portion is selectively attached to the rod. An indentation may be defined in the rod adjacent the upper end, and the grasping portion may comprise at least one engagement member that engages the indentation when the grasping portion is selectively attached to the rod. The indentation may be defined around a circumference of the rod. The at least one engagement member may comprise two opposing engagement members biased toward each other, and each of the two opposing engagement members may engage the indentation on an opposing side of the rod when the grasping portion is selectively attached to the rod. The upper end of the rod may be tapered such that the tapered upper end pushes apart the two opposing engagement members as the upper end of the rod is inserted into the grasping portion to attach the grasping portion and the rod. The grasping portion may comprise at least one release actuator which, when actuated, directly or indirectly pushes apart the two opposing engagement members to disengage the two opposing engagement members from the indentation to enable the grasping portion and the rod to be separated. The grasping portion may comprise a wedge in engagement with the at least one release actuator and with the two opposing engagement members such that actuation of the at least one release actuator moves the wedge between the two opposing engagement members to push apart the two opposing engagement members.

BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

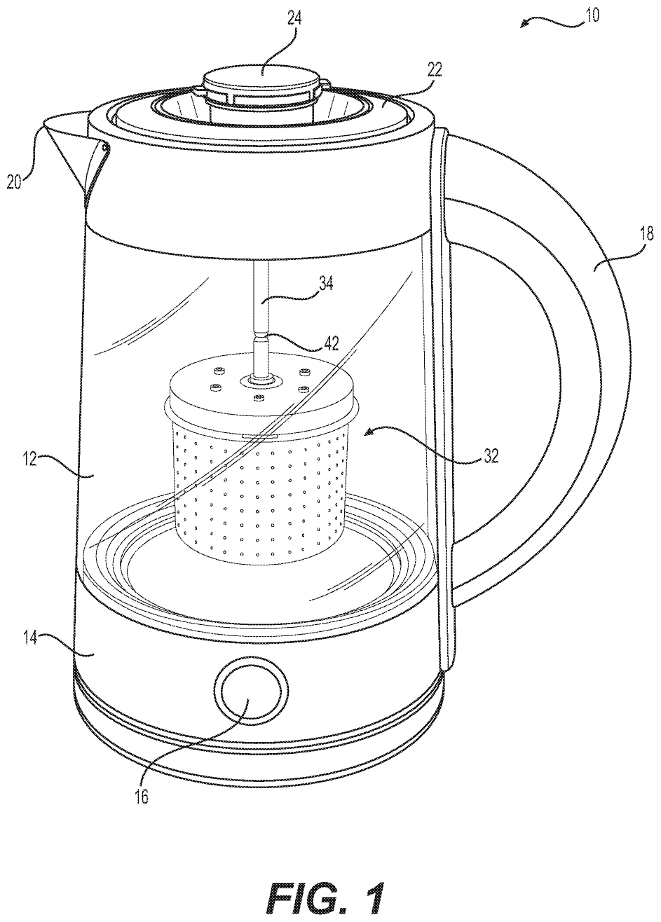

FIG. 1 is a perspective view of a tea kettle, according to one embodiment of the present disclosure, with its steeping basket in the lowered or submerged position.

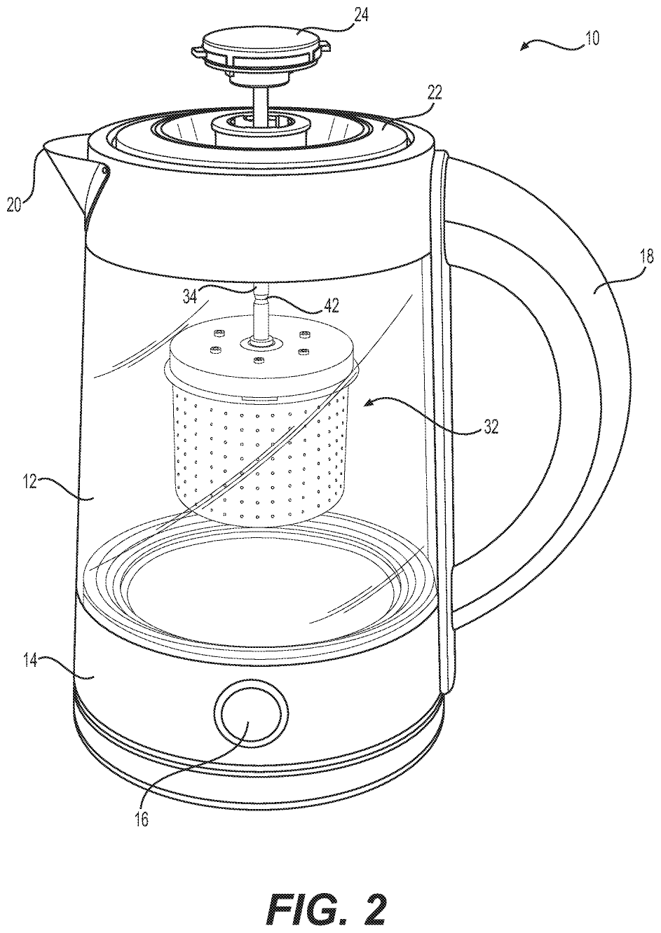

FIG. 2 is a perspective view of the tea kettle of FIG. 1, with its steeping basket in the raised position.

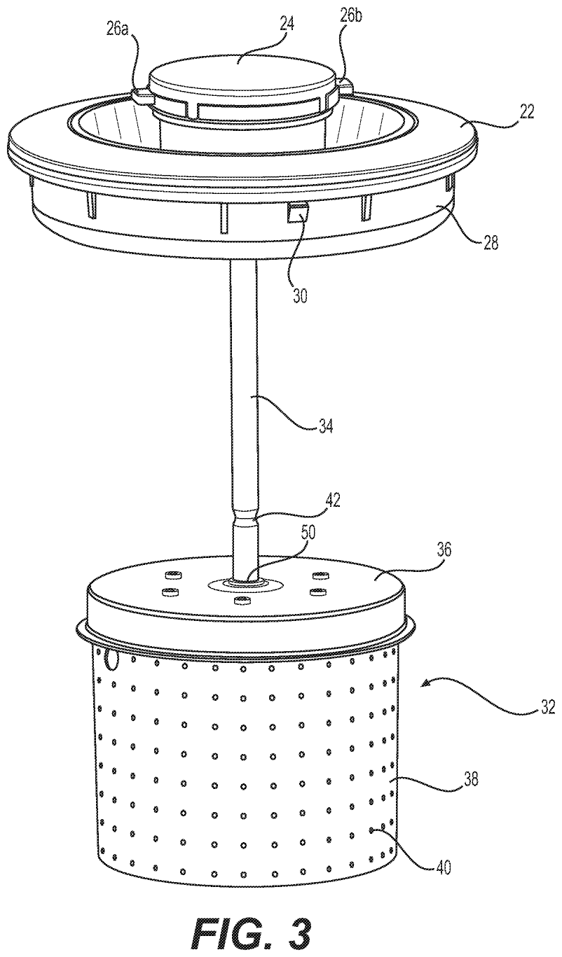

FIG. 3 is a perspective view of the lid and steeping basket removed from the tea kettle of FIG. 1, with the steeping basket in the lowered or submerged position.

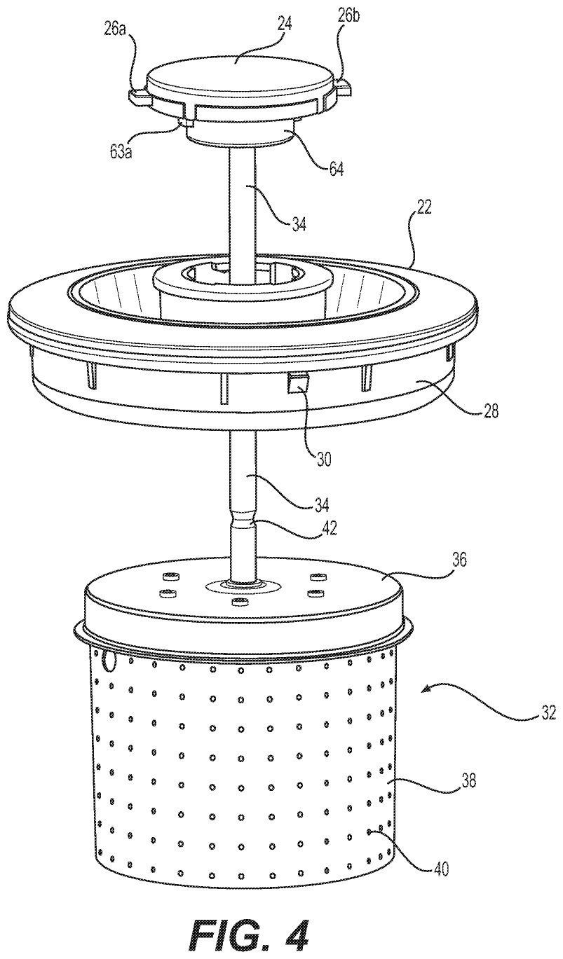

FIG. 4 is a perspective view of the lid and steeping basket removed from the tea kettle of FIG. 1, with the steeping basket in the raised position.

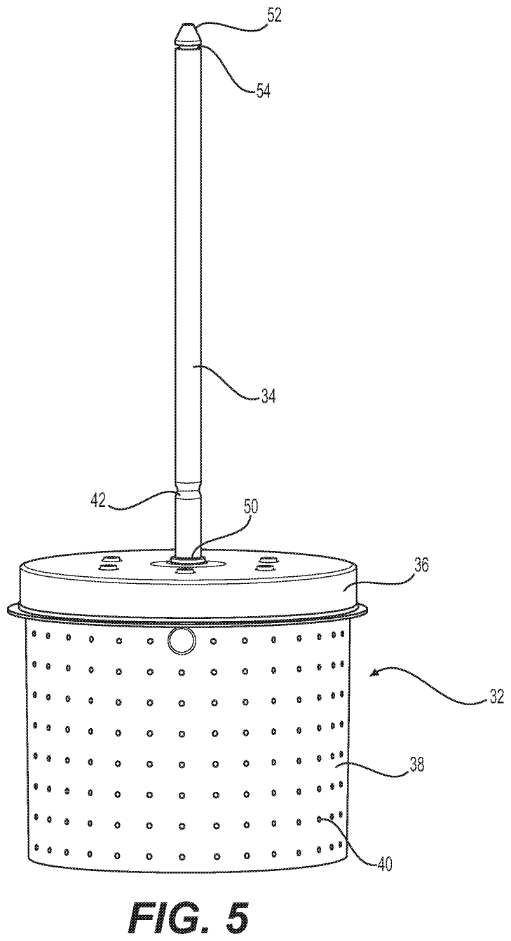

FIG. 5 is a perspective view of the steeping basket separated from the lid of the tea kettle of FIG. 1.

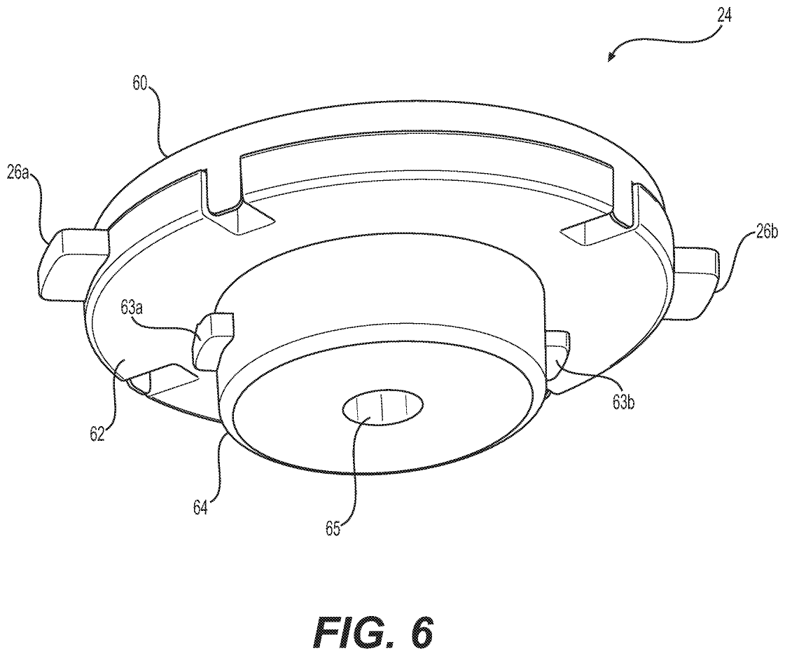

FIG. 6 is a perspective view of the grasping portion of the tea kettle of FIG. 1.

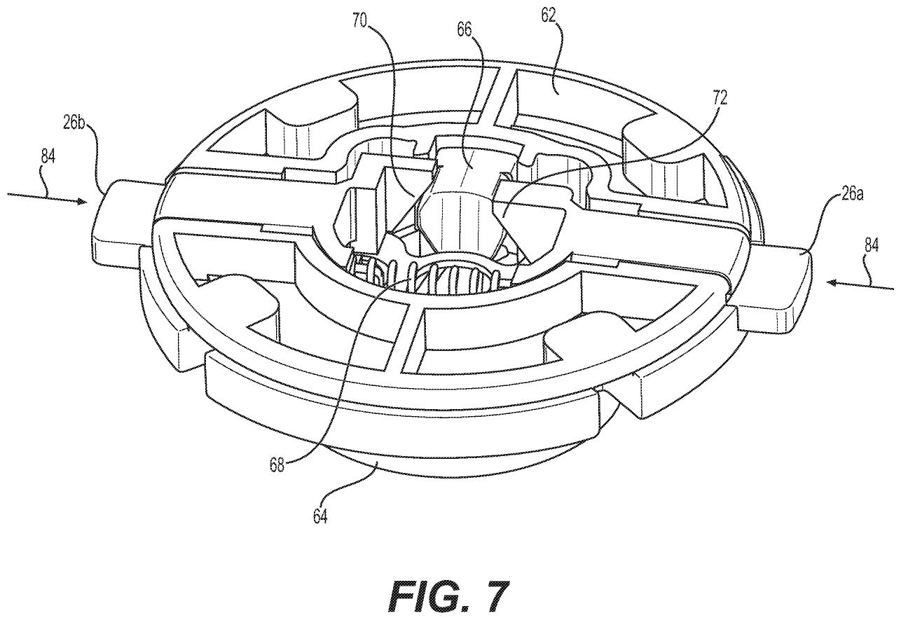

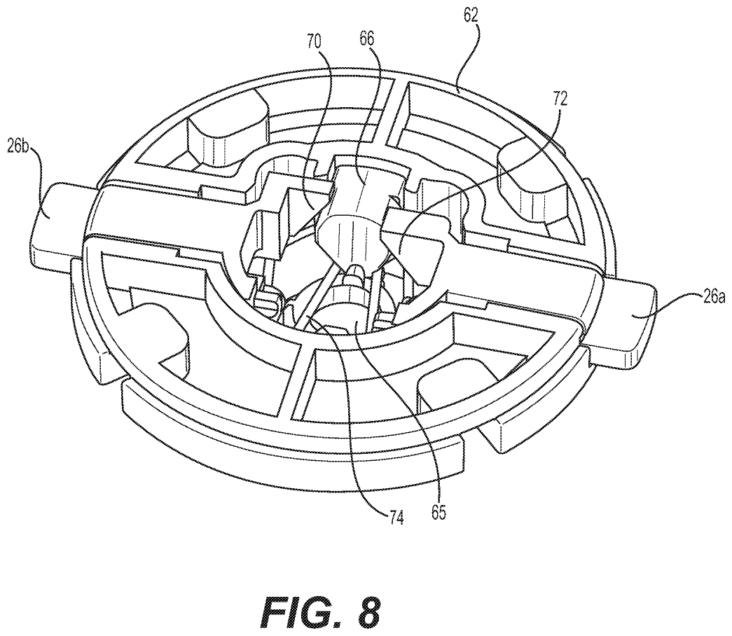

FIGS. 7-9 are perspective views of the grasping portion of FIG. 6, with its top cover removed.

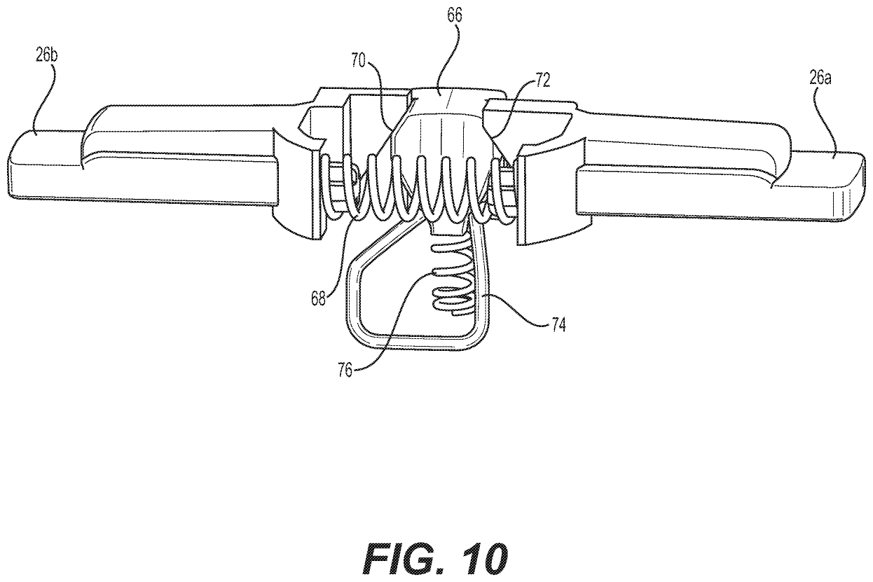

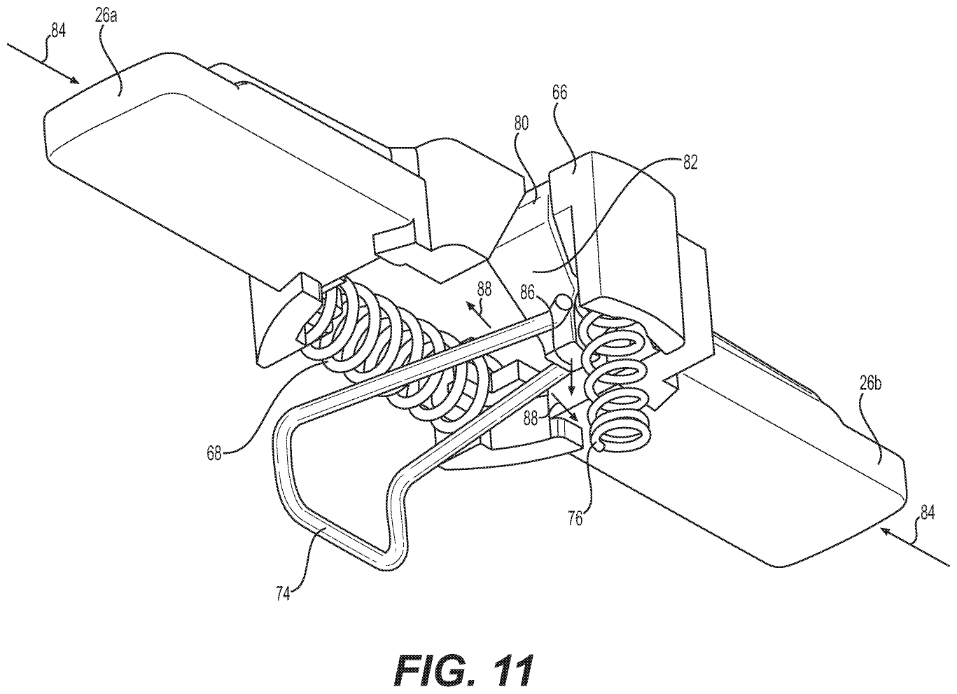

FIGS. 10 and 11 are perspective views of internal components of the grasping portion of FIG. 6.

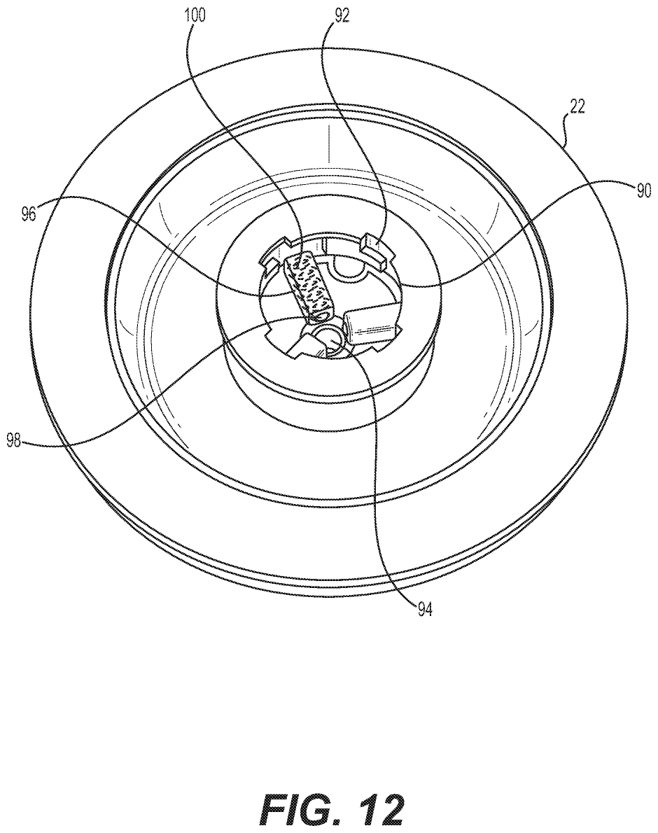

FIG. 12 is a view of the lid separated from the steeping basket of the tea kettle of FIG. 1.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

Referring to the drawings in detail, wherein like numerals indicate like elements throughout, FIGS. 1-12 illustrate an apparatus for brewing beverages, namely a tea kettle, in accordance with a preferred embodiment of the present disclosure. The tea kettle herein shown and described is an electric tea kettle, in that it would have an electrically-powered internal heat source (not illustrated). However, an apparatus for brewing beverages of embodiments of the present disclosure may be a non-electric tea kettle that is heated with an external heat source. Further, an apparatus for brewing beverages of embodiments of the present disclosure may be a beverage brewing apparatus other than a tea kettle.

The tea kettle 10 has a container portion 12 which defines a reservoir for receiving water to be heated and for receiving an infusible foodstuff for brewing a beverage, a base portion 14 containing a heating element (not illustrated) for heating water in the reservoir, an on/off switch 16 (or other suitable user interface) for controlling the operation of the tea kettle, a handle 18, a pour spout 20, and an open top end with a lid 22 that is removably mountable to the container portion 12 to selectively close off the top end. The lid 22 may have a lower skirt portion 28 that fits relatively snugly within the top end of the container portion 12. The lid 22 also may have one or more outwardly biased protrusions 30 that engage with the inside surface of the top end of the container portion to help retain the lid 22 in place on the top end.

The tea kettle 10 further has a steeping basket 32 that is suspended within the reservoir (when the lid is in place on the top end) via an elongated rod 34. The steeping basket 32 is selectively insertable into the reservoir through the open top end. The steeping basket 32 comprises a lid 36 that is attached to the lower end 50 of the rod 34 and a main body 38 that is selectively attachable to and separable from the lid 36. The main body 38 has a cylindrical wall (although other shapes may be used) in which a plurality of holes 40 are defined and a floor (which may or may not have holes) (not illustrated). The lid 36 and main body 38 of the steeping basket 32 define a chamber for receiving an infusible foodstuff such as tea leaves. The main body 38 separates from the lid 36 (via, for example, cooperating threads on the main body 38 and the lid 36) to add the infusible foodstuff into the chamber and then reattaches for brewing. The holes 40 allow water in the reservoir to enter the steeping basket 32 and contact the infusible foodstuff within the chamber.

The rod 34 is selectively insertable through a through-hole 94 of the lid 22, with the rod 34 and lid 22 being slidingly movable relative to each other when so inserted. The upper end 52 of the rod 34 is selectively attachable to and separable from a grasping portion 24 (described further below). When (i) the grasping portion 24 is attached to the rod 34, (ii) the steeping basket 32 is in the reservoir, and (iii) the lid 22 is closing off the open end, a user may move the grasping portion 24 up and down to correspondingly move the steeping basket 32 up and down within the reservoir. The steeping basket 32 is typically placed in the up or raised position (shown in FIG. 2) while the water in the reservoir is heated, and then the steeping basket 32 is lowered into a down or steeping position (shown in FIG. 1) to steep the tea leaves in the steeping basket 32. The steeping basket 32 is then typically raised again after the desired amount of steeping time. A circumferential channel 42 or similar indentation is defined in the rod 34 near the lower end 50. The channel 42 engages with one or more spring-loaded catches 96 (three are illustrated in FIG. 12) within a cavity 90 in the lid when the steeping basket 32 is raised up to help prevent sliding movement of the rod 34 which in turn helps retain the steeping basket 32 in the raised position. In the illustrated embodiment, the catches 96 each comprise a ball bearing 98 that partially protrudes from a housing and that is biased toward the rod 34 by a spring 100.

FIGS. 3 and 4 illustrate the lid 22, steeping basket 32, and grasping portion 24 in an attached arrangement and removed from the container portion 12 for, e.g., filling the basket with tea leaves or for cleaning. As discussed above, the awkwardly-shaped structure of the attached arrangement shown in FIGS. 3 and 4 may be difficult to clean as it may not fit well and/or sit stably on a dishwasher rack for cleaning. As such, the grasping portion 24 comprises at least one release actuator which, when actuated, enables the grasping portion to be separated from the upper end of the rod. In the illustrated embodiment, the grasping portion 24 comprises two opposing release actuators 26a, 26b which, when pushed inwardly (i.e., toward the centerline of the tea kettle, as indicated by arrows 84 in FIGS. 7 and 11) enables the grasping portion 24 to be separated from the upper end 52 of the rod 34. The grasping portion comprises a main body 62, a cover 60 concealing a hollow space in which internal components are located (as seen in FIGS. 7-9), and a downwardly protruding portion 64. A hole 65 is defined in the downwardly protruding portion 64 for receiving the upper end 52 of the rod 34 to enable the engagement of the rod 34 and the grasping portion 24. One or more tabs (two opposing ones 63a, 63b are shown in FIG. 6) protrude from the downwardly protruding portion 64 to selectively engage with one or more corresponding slots 92 (two opposing ones are shown in FIG. 12) in a twist-lock manner to selectively lock the lid 22 and grasping portion 24 together.

As seen in FIGS. 7-11, the release actuators 26a, 26b each have an elongated body that is contained within the main body 62 of the grasping portion 24 and normally hidden by the cover 60. A spring 68 biases the release actuators 26a, 26b outward (i.e., radially away from the centerline of the tea kettle). The elongated bodies of the release actuators 26a, 26b each terminate in a sloped edge 70, 72. A wedge 66 is located between the sloped edges 70, 72 of the release actuators 26a, 26b. The wedge 66 is upwardly biased by spring 76. The wedge 66 has opposing upper sloped sides 80 which slope (top-to-bottom) away from the midline of the wedge 66 and opposing lower sloped sides 82 which slope (top-to-bottom) toward the midline of the wedge 66.

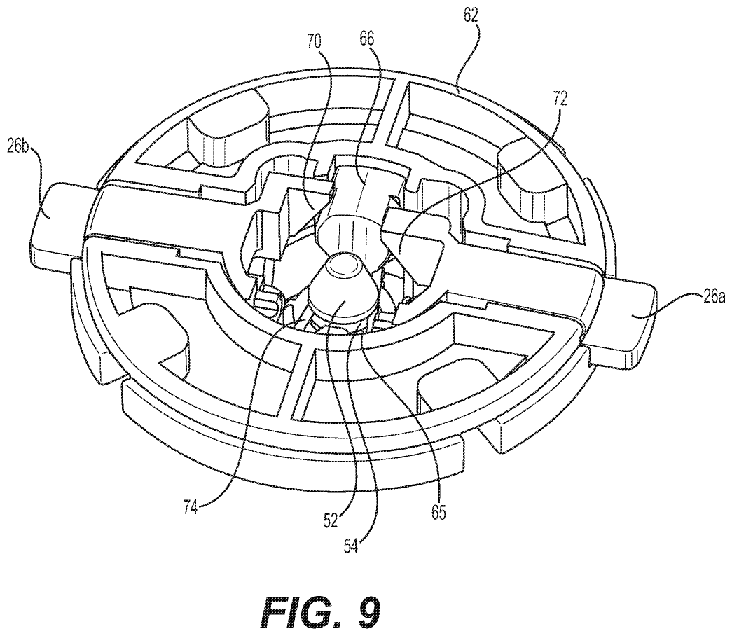

The grasping portion further comprises an engagement member 74 that has two free ends positioned on opposing sides of the hole 65 and adjacent to the opposing lower sloped sides 82 of the wedge 66. The engagement member 74 is constructed of a resilient material that causes the free ends to return to their original positions after being pushed apart. An indentation 54 is defined in the rod 34 adjacent the upper end 52 (typically around the entire circumference of the rod 34, as illustrated). The upper end 52 of the rod 34 is typically tapered, as illustrated. When the upper end 52 of the rod 34 is inserted into the hole 65 to attach the rod 34 and the grasping portion 24, the tapered upper end 52 pushes apart the two opposing free ends of the engagement member 74. The rod 34 is advanced until the opposing free ends of the engagement member 74 engage the indentation 54 on opposite sides of the rod 34 as seen in FIG. 9. The resilience of the opposing free ends of the engagement member 74 provide a snug engagement that helps retain the upper end 52 of the rod 34 until released (as described below).

To separate the grasping portion 24 and the rod 34, the release actuators 26a, 26b are pushed inwardly, as indicated by arrows 84. Each sloped edge 70, 72 of the release actuators 26a, 26b is adjacent to and engages a corresponding one of the opposing upper sloped sides 80 of the wedge 66. When the release actuators 26a, 26b are pushed inwardly, the engagement between the sloped edges 70, 72 of the release actuators 26a, 26b and the upper sloped sides 80 of the wedge 66 cause the wedge 66 to move downward as indicated by arrow 86 in FIG. 11. A lower end of the wedge 66 sits between the opposing free ends of the engagement member 74, as best seen in FIG. 11. As the wedge 66 moves downward, the opposing lower sloped sides 82 engage the opposing free ends of the engagement member 74 and push apart the two opposing free ends of the engagement member 74 as indicated by arrows 88 in FIG. 11. As the opposing free ends of the engagement member 74 are pushed apart, the opposing free ends of the engagement member 74 disengage from the indentation 54 to enable the upper end 52 of the rod 34 to be pulled out of the grasping portion 24 to separate the rod 34 and the grasping portion 24.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

That which is claimed:

1. An apparatus for brewing a beverage, the apparatus comprising:
a container portion defining a reservoir and having an open top end;
a lid for selectively closing off the open top end, the lid having a through-hole defined therein;
an elongated rod selectively insertable through the through-hole of the lid and slidingly movable relative to the lid when inserted, the rod having an upper end and a lower end;
a basket adapted for receiving and holding an infusible material, the basket attached to the lower end of the rod, the basket selectively insertable into the reservoir through the open top end, the basket having a plurality of holes defined therein adapted to allow water in the reservoir to enter the basket and contact the infusible material when the basket is inserted into the reservoir; and
a grasping portion selectively attachable to and separable from the upper end of the rod;
wherein, when (i) the grasping portion is attached to the rod, (ii) the basket is in the reservoir, and (iii) the lid is closing off the open top end, up and down movement of the grasping portion correspondingly moves the basket up and down within the reservoir.

2. The apparatus of claim 1, wherein the grasping portion comprises at least one release actuator which, when actuated, enables the grasping portion to be separated from the upper end of the rod.

3. The apparatus of claim 1, wherein a hole is defined in a bottom side of the grasping portion for selectively receiving the upper end of the rod when the grasping portion is selectively attached to the rod.

4. The apparatus of claim 3, wherein an indentation is defined in the rod adjacent the upper end; and
wherein the grasping portion comprises at least one engagement member that engages the indentation when the grasping portion is selectively attached to the rod.

5. The apparatus of claim 4, wherein the indentation is defined around a circumference of the rod.

6. The apparatus of claim 5, wherein the at least one engagement member comprises two opposing engagement members biased toward each other; and
wherein each of the two opposing engagement members engages the indentation on an opposing side of the rod when the grasping portion is selectively attached to the rod.

7. The apparatus of claim 6, wherein the upper end of the rod is tapered such that the tapered upper end pushes apart the two opposing engagement members as the upper end of the rod is inserted into the grasping portion to attach the grasping portion and the rod.

8. The apparatus of claim 6, wherein the grasping portion comprises at least one release actuator which, when actuated, directly or indirectly pushes apart the two opposing engagement members to disengage the two opposing engagement members from the indentation to enable the grasping portion and the rod to be separated.

9. The apparatus of claim 8, wherein the grasping portion comprises a wedge in engagement with the at least one release actuator and with the two opposing engagement members such that actuation of the at least one release actuator moves the wedge between the two opposing engagement members to push apart the two opposing engagement members.
